(19) United States
(12) Patent Application Publication
(10) Pub. No.: US 2014/0022273 A1
(43) Pub. Date: Jan. 23, 2014

(54) Surface Based Graphics Processing

(71) Applicants: Kiril Vidimce, Cambridge, MA (US); Marco Salvi, San Francisco, CA (US)

(72) Inventors: Kiril Vidimce, Cambridge, MA (US); Marco Salvi, San Francisco, CA (US)

(21) Appl. No.: 13/992,886

(22) PCT Filed: Oct. 18, 2011
(86) PCT No.: PCT/US11/56705

§ 371 Date: Sep. 26, 2013

(51) Int. Cl. G06T 5/00

(52) U.S. Cl. CPC G06T 5/00
USPC 345/589

(57) ABSTRACT

In some cases, instead of providing one color sample for every primitive overlying a pixel, surfaces made up of more than one primitive may be identified. In some cases, a surface may be identified that is likely to be of the same color. So, in such case, only one color sample may be needed for more than one primitive.

### BACKGROUND

This relates generally to graphics processing.

Generally, in connection with graphics processing, an object is tessellated into a large number of triangles. Each triangle is used to represent the shape and color of a very small portion of an object. Then these characteristics may be used to determine how to render a pixel to recreate a graphical image.

One problem that arises in connection with graphics processing is called aliasing. It may be seen as staircase shaped edges on objects depicted in images when, in fact, the edge of the object is smooth or non-staircased.

To reduce aliasing, anti-aliasing techniques increase the number of samples that are used to represent the image. Of course, the more samples that are used, the more complex is the rendering and, generally, the poorer the performance.

### BRIEF DESCRIPTION OF THE DRAWINGS

FIG. 1 is a depiction of five fragments from five triangles that contribute to a pixel in accordance with one embodiment;

FIG. 2 is a depiction of the pixel of FIG. 1, representing the samples that were output for each of two distinctly identified surfaces in accordance with one embodiment;

FIG. 3 is a flow chart for one embodiment of the present invention;

FIG. 4 is a flow chart for another embodiment of the present invention; and

FIG. 5 is a schematic depiction for one embodiment of the present invention.

### DETAILED DESCRIPTION

In some embodiments, colors may be rendered, not based on triangles or fragments, but, rather, based on surfaces. In one embodiment, one color sample is used for each surface. In some cases, the number of color samples per pixel may be limited to two samples, one for foreground and one for background.

As a result, in some embodiments, a full complement of visibility samples may be used for example, to reduce aliasing, and a smaller number of color samples may be used to decrease processing complexity and to improve performance.

As used herein, a “surface” is an area that is likely to be of one color. A surface may be identified by analyzing the distance of the region from the camera, whether the region is represented by the same triangle, and the orientation of areas of the potential surface in space and, particularly, whether or not the areas have the same or substantially the same normals.

The idea of the surface is that if a region is locally flat throughout the region, then the entire region is likely to be of the same color. Thus, surface based graphics processing may be used to simplify the processing, including in those applications where surface based processing is used to improve anti-aliasing techniques.

Generally, in some embodiments, one sample is captured and shaded for each surface for each pixel, effectively merging fragments, such as primitives or triangles, that belong to the same surface. This merging may reduce the number of color samples that are stored and shaded for pixel, improving performance without reducing the number of visibility samples. Reducing the number of visibility samples may increase aliasing in some cases.

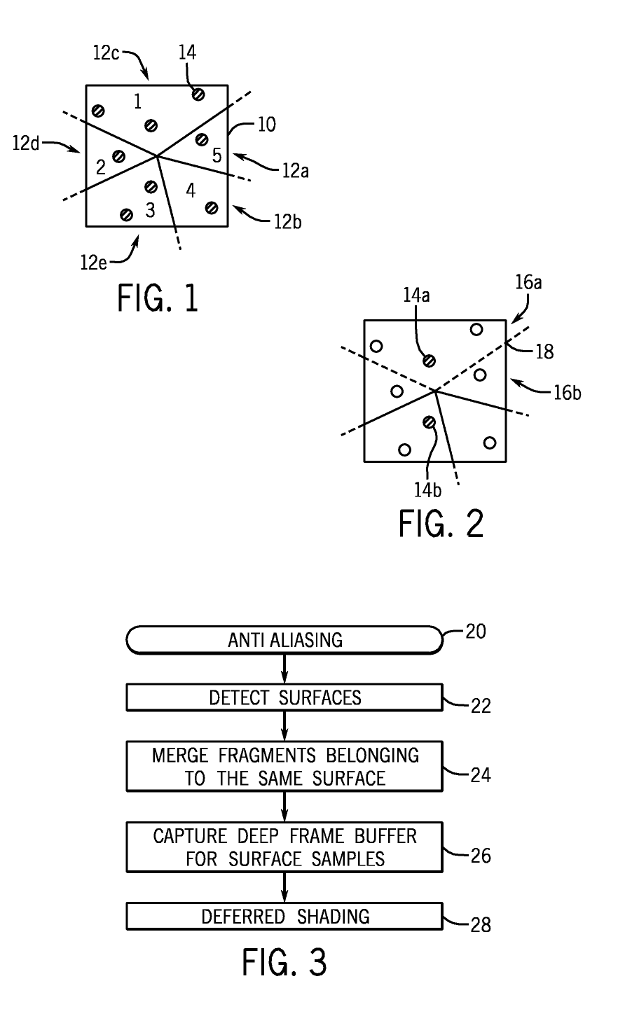

Thus, referring to FIG. 1, a pixel 10 may be overlapped in this example by five triangles 12a-12e, numbered one through five, on the pixel. The circles represent visibility samples. Visibility samples are those samples taken to determine whether the region of the pixel proximate to the sample is visible within the view frustrum. In addition, within each fragment are potential color samples that may be used to sample the color of a fragment of the pixel. If each of the samples 14, shown in FIG. 1, were used as a color sample, then there would be eight color samples for eight visibility samples. In some cases, this can result in processing complexity and performance reductions. Thus, in some embodiments, instead of using all of the color samples, only one sample from each of two surfaces may be used. In this case, the triangle 1 makes up one surface and triangles 2, 3, 4, and 5 make up the other surface.

The depiction of surfaces is better shown in FIG. 2, showing that there are eight visibility samples (represented by circles) and only two color samples, one color sample 14a being used for the surface 16a and the other color sample 14b being used for the surface 16b. The dividing line 18 between the two surfaces is indicated in dashed lines.

Referring next to FIG. 3, an anti-aliasing sequence 20, in accordance with one embodiment, may be implemented in software, hardware, and/or firmware. In software and firmware embodiments, it may be implemented by computer readable instructions stored in a non-transitory computer readable medium, such as an optical, semiconductor, or magnetic storage. In some cases, the storage may be associated with a graphics processor.

The sequence begins by identifying surfaces, as indicated in block 22. The information used to detect surfaces may be rendered. Information to detect surfaces may include depth, normal, and primitive identifier. The information may be rendered into a multi-sampled frame buffer. A multi-sampled frame buffer is the kind of buffer typically used for forward rendering. Next, the multi-sampled frame buffer is analyzed and fragments that belong to the same surface are merged (block 24). Each surface may be assigned a unique sample in one embodiment. Up to n surfaces per pixel may be detected and stored, where n may be fixed a priori. The system may be configured to detect and store any number of surfaces per pixel.

Next, as shown in block 26, the surface samples are captured in a deep or geometry frame buffer via a traditional forward rendering process in a third phase. In the final phase, shown at block 28, a typical deferred shading pass may be done on the collected surface samples from the third phase. Only one sample is shaded per surface, instead of one sample per primitive or triangle, in some embodiments.

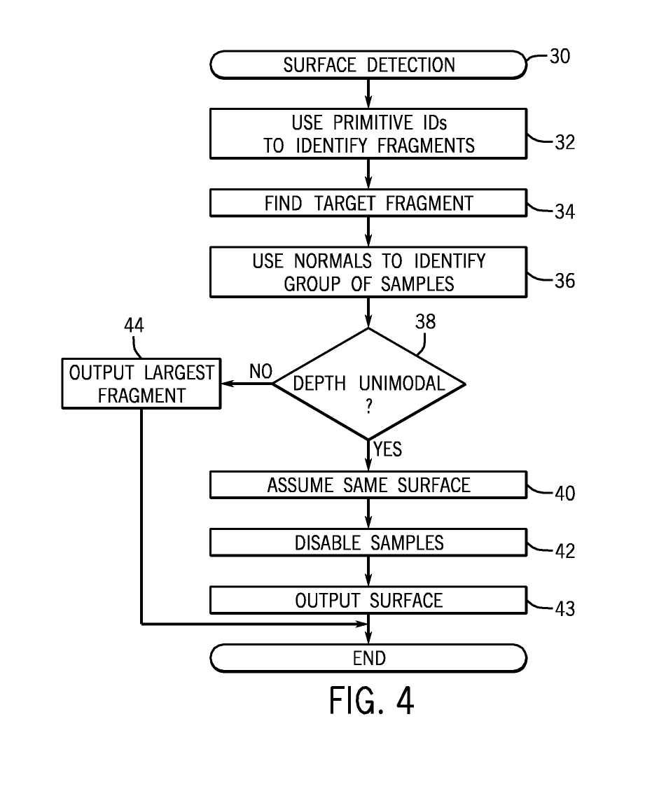

The surface detection sequence 30, shown in FIG. 4, may be implemented in hardware, software, and/or firmware. In software and firmware embodiments, it may be implemented by computer readable instructions stored in a non-transitory computer readable medium, such as an optical, semiconductor, or magnetic storage device. Again, the sequence may be stored in storage associated with the graphics processing unit, in one embodiment. The processing may be performed on a per-pixel basis in one embodiment.

In one per-pixel sequence, all of the active samples are initially enabled. Then, for each output sample, so long as the set of samples is not empty, the primitive identifiers of all the active samples are used to identify the fragments, as indicated in block 32. Then the fragment F that is the largest (because it has the highest sample coverage) is found, as indicated in block 34. Next, the normals of the active samples are used to identify M, a group of candidate samples for merging those normals that are aligned with the fragment F, as indicated in block 36.

A check at diamond 38 determines whether the depth distribution of samples of M and F is unimodal. As used herein, a unimodal distribution is a distribution with one peak or a distribution that is defined around one average value of samples. If so, it is assumed that those samples are part of the same surface, as indicated in block 40. Their coverage and output F all combined for subsequent shading and written out samples are disabled from the active mask because they will not be used, as indicated in block 42. Then the detected surface is outputted, as indicated in block 43. If the depth is not unimodal (i.e., if it is bimodal), as determined at diamond 38, then F is output with its original coverage, as indicated in block 44.

For each of the samples for each surface of one given pixel in an example where n=2, the merging algorithm is used in a configuration with a preset number of visibility samples per pixel, in one embodiment, eight visibility samples per pixel. Thus, the sequence of FIG. 4, with respect to the example given in FIG. 1, uses the primitive identifiers of the active samples to identify the fragments 1-5. The largest fragment F with the highest sample coverage is the fragment 1. Then the normals of the active samples are used to identify M, a group of candidate samples for merging whose normals are aligned with F. In this example, M is empty, since the normals for the fragments 2, 3, 4, and 5 do not align with the fragment 1. Therefore, F is output. Namely, the output surface is fragment #1, with its original coverage of three samples. The other samples of fragment 1 are disabled from the set of active samples. For sample #2, the primitive identifiers are used to identify the active samples and to identify the fragments 2-5.

The largest fragment F with the highest sample coverage is the fragment #3. The normals of the active samples are used to identify M, a group of candidate samples for merging whose normals are aligned with F. In this case, M includes all the remaining samples, including those that belong to the fragments 2, 4, and 5. The depth distribution of the samples of M and F is unimodal and, therefore, we assume that they are part of the same surface. Thus, we output F, which is primitive 3 as the second surface, for subsequent shading with extended coverage of 2+3, which is equal to 5 samples.

In some cases, determining if samples belong to the same surface by finding the largest fragment F with the largest coverage may be accelerated. Each sample triangle identifier may be 32 bits in one embodiment. To indicate which triangle the sample is related to, instead of using the triangle identifier, less than all the bits, for example only the seven least significant bits of the identifier, may be used. Using seven least significant bits, results in a significantly faster process without significantly adversely affecting quality.

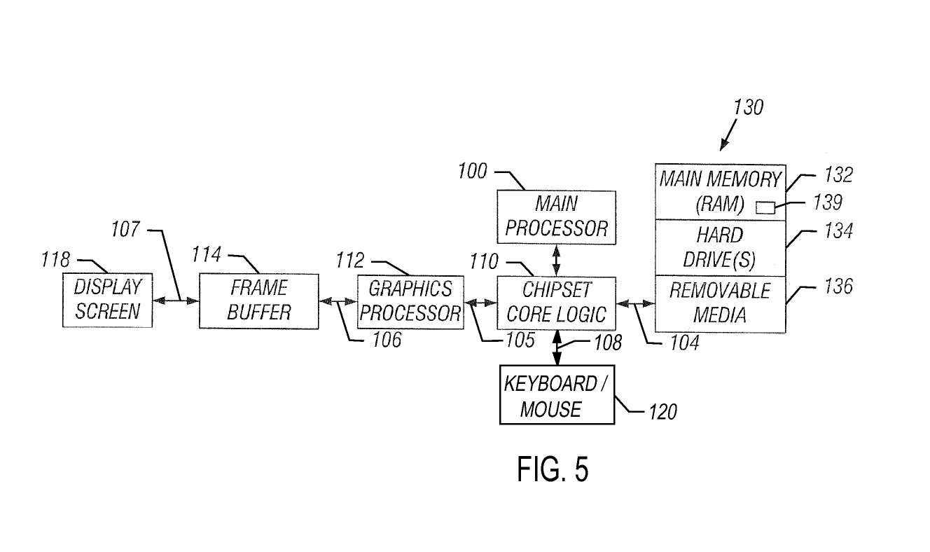

The computer system 130, shown in FIG. 5, may include a hard drive 134 and a removable medium 136, coupled by a bus 104 to a chipset core logic 110. The computer system may be any computer system, including a smart mobile device, such as a smart phone, tablet, or a mobile Internet device. A keyboard and mouse 120, or other conventional components, may be coupled to the chipset core logic via bus 108. The core logic may couple to the graphics processor 112, via a bus 105, and the central processor 100 in one embodiment. The graphics processor 112 may also be coupled by a bus 106 to a frame buffer 114. The frame buffer 114 may be coupled by a bus 107 to a display screen 118. In one embodiment, a graphics processor 112 may be a multi-threaded, multi-core parallel processor using single instruction multiple data (SIMD) architecture.

In the case of a software implementation, the pertinent code may be stored in any suitable semiconductor, magnetic, or optical memory, including the main memory 132 (as indicated at 139) or any available memory within the graphics processor. Thus, in one embodiment, the code to perform the sequences of FIGS. 3 and 4 may be stored in a non-transitory machine or computer readable medium, such as the memory 132, and/or the graphics processor 112, and/or the central processor 100 and may be executed by the processor 100 and/or the graphics processor 112 in one embodiment.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
using a computer processor to render an image by identifying surfaces likely to be of the same color.

2. The method of claim 1 including using normals to identify a surface.

3. The method of claim 1 including using depth to identify a surface.

4. The method of claim 3 including determining if the depth of a plurality of primitives is unimodal to identify a surface.

5. The method of claim 1 including identifying a surface before rendering color.

6. The method of claim 1 including identifying a surface to reduce the number of color samples per pixel.

7. The method of claim 6 including identifying surfaces for anti-aliasing.

8. The method of claim 1 including using not more than two color samples per pixel.

9. The method of claim 1 including using primitive identifiers to identify primitives.

10. The method of claim 9 including using less than all of the bits of primitive identifiers.

11. A non-transitory computer readable medium storing instructions to enable a computer to:
render an image by identifying surfaces likely to be of the same color.

12. The medium of claim 11 further storing instructions to use normals to identify a surface.

13. The medium of claim 11 further storing instructions to use depth to identify a surface.

14. The medium of claim 13 further storing instructions to determine if the depth of a plurality of primitives is unimodal to identify a surface.

15. The medium of claim 11 further storing instructions to identify a surface before rendering color.

16. The medium of claim 11 further storing instructions to identify a surface to reduce the number of color samples per pixel.

17. The medium of claim 16 further storing instructions to identify surfaces for anti-aliasing.

18. The medium of claim 11 further storing instructions to use not more than two color samples per pixel.

19. The medium of claim 11 further storing instructions to use primitive identifiers to identify primitives.

20. The medium of claim 19 further storing instructions to use less than all of the bits of primitive identifiers.

21. An apparatus comprising:
a processor to render an image by identifying surfaces likely to be of the same color; and
a storage coupled to said processor.

22. The apparatus of claim 21, said processor to use normals to identify a surface.

23. The apparatus of claim 21, said processor to use depth to identify a surface.

24. The apparatus of claim 23, said processor to determine if the depth of a plurality of primitives is unimodal to identify a surface.

25. The apparatus of claim 21, said processor to identify a surface before rendering color.

26. The apparatus of claim 21, said processor to identify a surface to reduce the number of color samples per pixel.

27. The apparatus of claim 26, said processor to identify surfaces for anti-aliasing.

28. The apparatus of claim 21, said processor to use not more than two color samples per pixel.

29. The apparatus of claim 21, said processor to use primitive identifiers to identify primitives.

30. The apparatus of claim 29, said processor to use less than all of the bits of primitive identifiers.
